(19) United States
(12) Patent Application Publication
(10) Pub. No.: US 2014/0085645 A1
(43) Pub. Date: Mar. 27, 2014

(54) IMAGE PROCESSING APPARATUS AND IMAGE PROCESSING METHOD

(71) Applicant: Oki Data Corporation, Tokyo (JP)

(72) Inventor: Hirohito OKAZAKI, Tokyo (JP)

(73) Assignee: Oki Data Corporation, Tokyo (JP)

(21) Appl. No.: 14/033,858

(22) Filed: Sep. 23, 2013

(30) Foreign Application Priority Data
Sep. 24, 2012 (JP) 2012-209694

(51) Int. Cl. G06K 15/02

(52) U.S. Cl. CPC G06K 15/1868
USPC 358/1.2

(57) ABSTRACT

An image processing apparatus includes a control unit that processes a plurality of pages by aggregating a certain number of pages among the plurality of pages into an output page, and a specifying unit that specifies a specific page among the plurality of pages and excludes the specific page from an object of the aggregation by the control unit. When an orientation of the specific page is different from an orientation of the output page containing aggregated pages, the control unit aligns the orientation of the specific page and the orientation of the output page with each other.

### BACKGROUND OF THE INVENTION

The present invention relates to an image processing apparatus and an image processing method. Particularly, the present invention relates to an image processing apparatus and an image processing method for printing a plurality of pages on a single page of a print medium.

There is an image forming apparatus having an N-up printing function (also referred to as an aggregate printing function) to print a plurality of pages of a document on a single page of print medium. Such an image forming apparatus is disclosed in, for example, Japanese Laid-open Patent Publication No. 2008-221498 (FIGS. 11 and 12).

However, there is a possibility that the document may contain a specific page (for example, a cover page) that a user does not want to reduce in size. In the conventional image forming apparatus, the specific page is also reduced in a similar manner to other pages. Therefore, the specific page becomes smaller than the user wants, and readability of the specific page may be degraded.

### SUMMARY OF THE INVENTION

An aspect of the present invention is intended to provide an image processing apparatus and an image processing method capable of preventing a specific page from being reduced more than necessary.

According to an aspect of the present invention, there is provided an image processing apparatus including a control unit that processes a plurality of pages by aggregating a certain number of pages among the plurality of pages into an output page, and a specifying unit that specifies a specific page among the plurality of pages and excludes the specific page from an object of the aggregation by the control unit. When an orientation of the specific page is different from an orientation of the output page containing aggregated pages, the control unit aligns the orientation of the specific page and the orientation of the output page with each other.

With such a configuration, the specific page is excluded from the aggregation, and therefore the specific page is not reduced more than necessary.

According to another aspect of the present invention, there is provided an image processing method including a first step of determining to process a plurality of pages by aggregating a certain number of pages among the plurality of pages into an output page, a second step of specifying a specific page among the plurality of pages and excluding the specific page from an object of the aggregation, and a third step performed when an orientation of the specific page is different from an orientation of the output page containing aggregated pages. The third step aligns the orientation of the specific page and the orientation of the output page with each other.

Further scope of applicability of the present invention will become apparent from the detailed description given hereinafter. However, it should be understood that the detailed description and specific embodiments, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

In the attached drawings:

FIG. 1 is a block diagram showing a configuration of a system including an image processing apparatus according to Embodiment 1 of the present invention;

FIG. 2 is a block diagram showing an inner configuration of a storage unit of the system shown in FIG. 1;

FIG. 3 is a block diagram showing an inner configuration of a control unit of the system shown in FIG. 1;

FIG. 4 is a schematic view showing an example of a user interface displayed on a display unit of a personal computer according to Embodiment 1;

FIG. 5 is a schematic view showing a 7-page document oriented in a longitudinal (portrait) orientation and including a cover page and content pages subject to an N-up printing according to Embodiment 1;

FIG. 6A is a schematic view for illustrating the longitudinal (portrait) orientation of a page;

FIG. 6B schematic view for illustrating a lateral (landscape) orientation of the page;

FIG. 7 is a flowchart showing an aggregation processing performed by the control unit according to Embodiment 1;

FIGS. 8A, 8B, 8C and 8D are schematic views showing layouts of output pages of a 2-up printing according to Embodiment 1;

FIGS. 9A, 9B and 9C are schematic views showing layouts of output pages of a 4-up printing according to Embodiment 1;

FIGS. 10A and 10B are schematic views showing layouts of output pages of a 6-up printing according to Embodiment 1;

FIGS. 100 and 10D are schematic views showing layouts of output pages of an 8-up printing according to Embodiment 1;

FIGS. 11A and 11B are schematic views showing layouts of output pages of a 9-up printing according to Embodiment 1;

FIGS. 12A and 12B are schematic views showing layouts of output pages of a 16-up printing according to Embodiment 1;

FIG. 13 is a schematic view showing a 7-page document oriented in the lateral (landscape) orientation and including a cover page and content pages subject to the N-up printing according to Embodiment 1;

FIGS. 14A, 14B, 14C and 14D are schematic views showing layouts of output pages of the 2-up printing according to Embodiment 1;

FIGS. 15A, 15B and 15C are schematic views showing layouts of output pages of the 4-up printing according to Embodiment 1;

FIGS. 16A and 16B are schematic views showing layouts of output pages of the 6-up printing according to Embodiment 1;

FIGS. 17A and 17B are schematic views showing layouts of output pages of the 8-up printing according to Embodiment 1;

FIGS. 18A and 18B are schematic views showing layouts of output pages of the 9-up printing according to Embodiment 1;

FIGS. 19A and 19B are schematic views showing layouts of output pages of the 16-up printing according to Embodiment 1;

FIGS. 20A, 20B, 20C and 20D are schematic views showing layouts of output pages of the 2-up printing of comparison example in the case where the orientation of the cover page and the orientation of the output page (containing aggregated content pages) are different from each other;

FIG. 21 is a schematic view showing an example of a user interface displayed on a display unit of a personal computer according to Embodiment 2;

FIGS. 22A and 22B are schematic views showing layouts of output pages of the 6-up printing according to Embodiment 2 in the case where a centering of the cover page is performed;

FIG. 23 is a flowchart showing an aggregation processing performed by a control unit according to Embodiment 2;

FIG. 24 is a schematic view showing an example of a user interface displayed on a display unit of a personal computer according to Embodiment 3;

FIG. 25 is a schematic view showing a display screen including a 7-page document and checkboxes displayed on the display unit according to Embodiment 3; and

FIGS. 26A, 26B, 26C, 26D and 26E are schematic views showing layouts of output pages of a 2-up printing according to Embodiment 3 in the case where a cover page and chapter pages are rotated and centered.

### DETAILED DESCRIPTION OF THE PREFERRED EMBODIMENT

Hereinafter, an image processing apparatus and an image processing method according to embodiments of the present invention will be described with reference to drawings.

### Embodiment 1

### <Configuration>

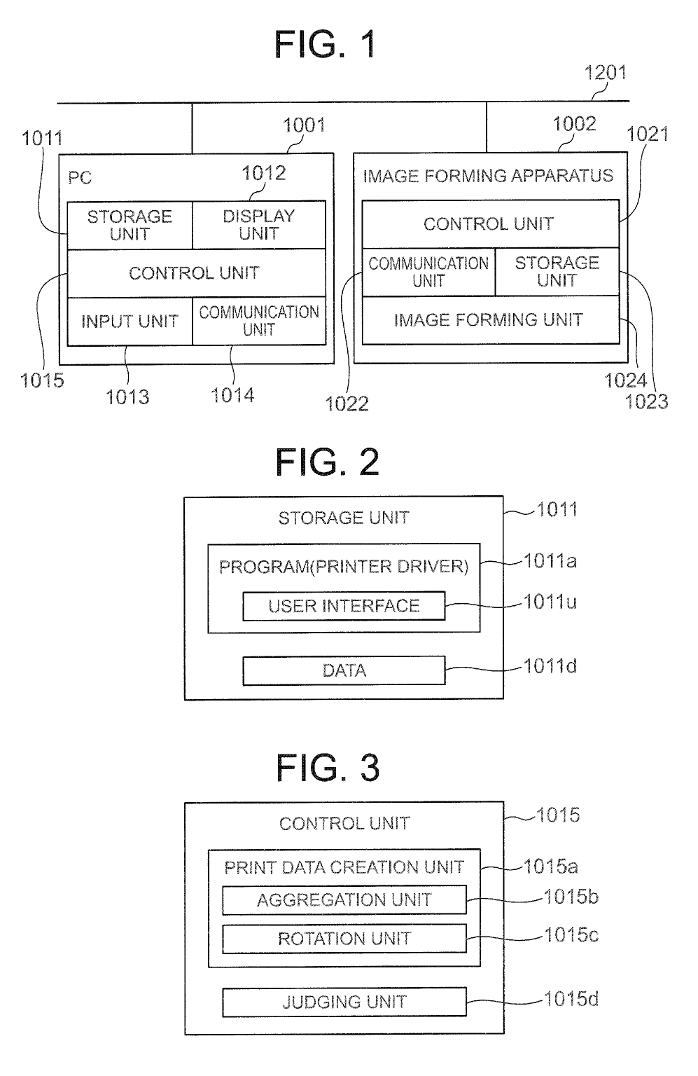

FIG. 1 is a perspective view showing a configuration of a system including an image processing apparatus according to Embodiment 1 of the present invention. The system includes a personal computer (hereinafter referred to as a PC) 1001 as an image processing apparatus, an image forming apparatus 1002, and a LAN (Local Area Network) cable 1201 connecting the PC 1001 and the image forming apparatus 1002. In this regard, the LAN cable 1201 can be replaced with a USB (Universal Serial Bus) or other connection units.

The PC 1001 includes a storage unit 1011, a display unit 1012, a control unit 1015, an input unit 1013, and a communication unit 1014. The storage unit 1011 includes, for example, a memory or a hard disc. The control unit 1015 includes a CPU (Central Processing Unit). The input unit 1013 includes, for example, a keyboard or a mouse. The communication unit 1014 includes, for example, an Ethernet port or a USB port.

FIG. 2 is a block diagram showing an internal configuration of the storage unit 1011 of the PC 1001. FIG. 3 is a block diagram showing an internal configuration of the control unit 1015 of the PC 1001.

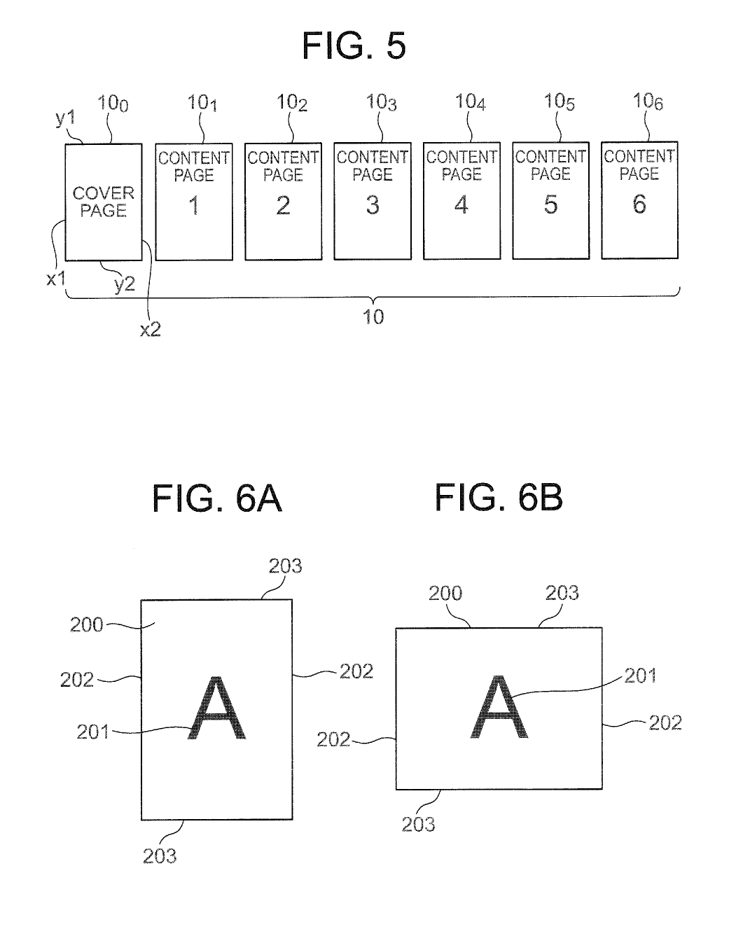

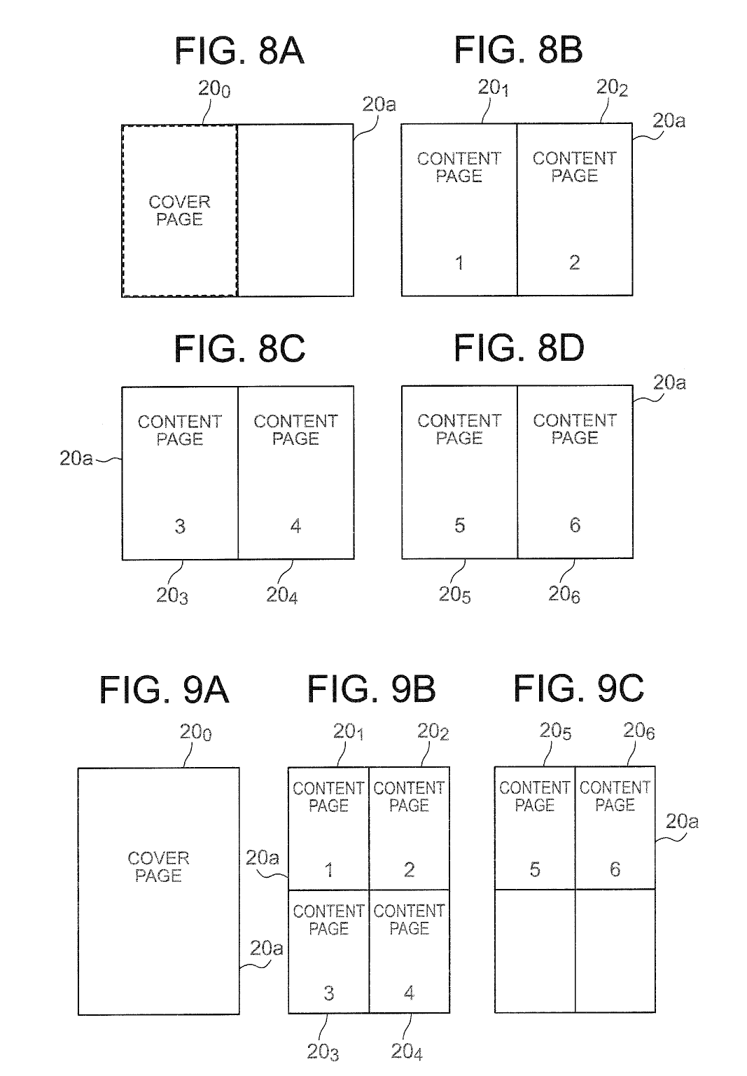

As shown in FIG. 2, the storage unit 1011 stores a program such as a printer driver 1011a and other applications. The printer driver 1011a includes a user interface 1011u. The user interface 1011u functions as a specifying unit that specifies a specific page to be excluded from an object of aggregation as described later. The storage unit 1011 can store data 1011d. For example, the storage unit 1011 can store document data (see FIGS. 5, 13 and 25), and file data (see FIGS. 8A through 12B, FIGS. 14A through 19B, FIGS. 26A through 26E) created by a print data creation unit 1015a (described later).

In this regard, the term “aggregation” is used to indicate processing to arrange data of a certain number of pages of a document on a single page (i.e., an output page) in a predetermined layout. The output page can be defined as a surface of a print medium. In this regard, the output page can also be defined as a page in the form of data (for example, PDF data). The term “N-up” is used to indicate a processing to aggregate N pages of the document on the single page (N is an integer greater than 1). The number of pages (N) aggregated into the single page is also referred to as “Up number”. The term “document” is used to indicate a string of page data which is an object of aggregation.

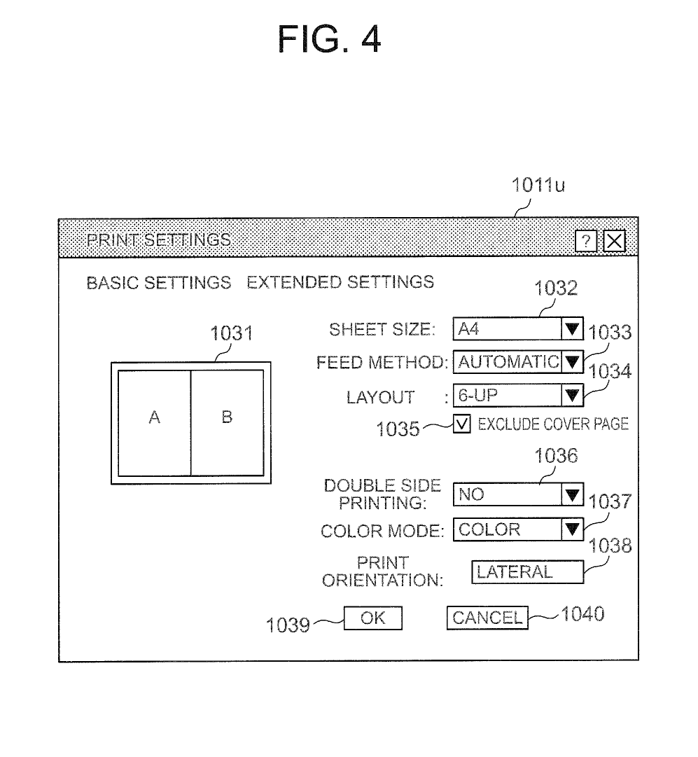

In FIG. 3, several functions of the control unit 1015 are illustrated as blocks for convenience sake. The control unit 1015 performs programs such as the printer driver 1011a or other applications, and displays the user interface 1011u (FIG. 4) as the dialog box on the display unit 1012.

The control unit 1015 includes a print data creation unit 1015a and a judging unit 1015d. The judging unit 1015d judges whether it is necessary to rotate a cover page 10₀ (i.e., a specific page) of the document 10 by 90 degrees in order to align an orientation of the cover page 10₀ and an orientation of the output page (containing aggregated content pages) of the document 10 as described later. If the orientation of the cover page 10₀ and the orientation of the output page (containing aggregated content pages) is different from each other by 90 degrees, the judging unit 1015d judges that it is necessary to rotate the cover page 10₀. If the orientation of the cover page 10₀ and the orientation of the output page are the same each other, the judging unit 1015d judges that it is not necessary to rotate the cover page 10₀. The print data creation unit 1015a includes an aggregation unit 1015b and a rotation unit 1015c. The aggregation unit 1015b creases print data by aggregating the content pages (for example, the content pages 10₁-10₆ as shown in FIG. 5) of the document 10.

The rotation unit 1015c creases print data by reducing the size of the cover page 10₀ at a requisite (highest) reduction ratio and by rotating the cover page 10a by 90 degrees based on a result of judgment of the judging unit 1015d. That is, if the judging unit 1015d judges that it is necessary to rotate the cover page 10₀ (in order to align the orientation of the cover page 10₀ and the orientation of the output page with each other), the rotation unit 1015c creates the print data by reducing the size of the cover page 10₀ at the requisite (highest) reduction ratio and by rotating the cover page 10a by 90 degrees. In contrast, if the judging unit 1015d judges that it is unnecessary to rotate the cover page 10₀, the rotation unit 1015c creates the print data without reducing and rotating the cover page 10₀. In this way, the print data creation unit 1015a creates file data using the rotation unit 1015c and the aggregation unit 1015b based on the judgment of necessity of the rotation of the cover page 10₀ by the judging unit 1015d (in accordance with a user's specifying operation. at the user interface 1011u), and outputs the created file data to the storage unit 1011 and the communication unit 1014.

The display unit 1012 displays the user interface 1011u (see FIG. 4). The user can view the user interface 1011u, and perform settings for the programs using the input unit 1013. The communication unit 1014 is connected to another component (here, the image forming apparatus 1002) via the LAN cable 1201, and electrically communicates with the component.

The image forming apparatus 1002 includes a control unit 1021, a communication unit 1022, a storage unit 1023, and an image forming unit 1024. The control unit 1021 includes, for example, a CPU. The communication unit 1024 includes, for example, Ethernet port. The storage unit 1023 includes, for example, a memory or a hard disk. The image forming unit 1024 is configured to perform printing on a print sheet (i.e., a print medium).

FIG. 4 is a schematic view showing an example of the user interface 1011u displayed on the display unit 1012 by means of the printer driver 1011a of the PC 1001. As shown in FIG. 4, the user interface 1011u includes a sheet-size specifying section 1032 (i.e., a medium size specifying section), a feed method specifying section 1033, a multipage specifying section 1034, a cover page exclusion specifying section 1035, a double-side printing specifying section 1036 and a color/monochrome specifying section 1037. The sheet-size specifying section 1032 is provided for selecting a size of the print sheet. The feed method specifying section 1033 is provided for specifying a position (i.e., a cassette or tray) from which the print sheet is to be fed. The multipage specifying section 1034 is provided for specifying the up-number N which is used to determine a layout of the aggregated pages on the output page. The cover page exclusion specifying section 1035 is provided for specifying whether or not to exclude the cover page from the aggregation when the N-up printing is performed. The double-side printing specifying section 1036 is provided for specifying whether or not to perform a double-side printing. The color/monochrome specifying section 1037 is provided for selecting one of a color printing and a monochrome printing. The user performs settings at these specifying sections 1032 through 1037 using the input unit 1013 while viewing the user interface 1011u.

A preview display section 1031 displays a simplified image based on settings at the specifying sections 1032 through 1037.

A print orientation display section 1038 automatically displays an orientation of the output page, i.e., “longitudinal” (portrait) or “lateral” (landscape) based on the up-number N specified at the multipage specifying section 1034 as described later. Further, an OK button (i.e., an enter button) 1039 and a cancel button 1040 are provided for confirming and cancelling the settings specified at the sections 1032 through 1037.

FIG. 5 shows an example of the 7-page document 10 which is subject to the N-up printing according to Embodiment 1. The document 10 includes the cover page 10₀ and the content pages 10₁-10₆. As shown in FIG. 5, the pages 10₀-10₆ of the document 10 are oriented in a longitudinal (portrait) orientation.

Here, when the document 10 is oriented in such a manner that left and right edges x1 and x2 of the document 10 are longer than upper and lower edges y1 and y2 of the document 10 as shown in FIG. 5, it is defined that the document 10 is oriented in the longitudinal orientation. In contrast, when the document 10 is oriented in such a manner that left and right edges x1 and x2 are shorter than upper and lower edges y1 and y2, it is defined that the document 10 is oriented in the lateral orientation (see FIG. 13).

FIGS. 6A and 6B are schematic views for illustrating an orientation of the page on the print sheet (i.e., the output page). In FIGS. 6A and 6B, the print sheet 200 is oriented in an orientation so that a printed image 201 (“A”) on the print sheet 200 is correctly readable. In this state, if left and right edges 202 of the print sheet 200 are longer than upper and lower edges 203 as shown in FIG. 6A, it is described that the print sheet 200 is oriented in the longitudinal (portrait) orientation.

If the upper and lower edges 203 are longer than the left and right edges 202 of the print sheet 200 as shown in FIG. 6B, it is described that the print sheet 200 is oriented in the lateral (landscape) orientation.

Here, the print sheet (i.e., the print medium) will be described. The print sheet has a shape of a root rectangle. The root rectangle is a shape such that a ratio of a width W (i.e., a length of a shorter edge) to a length L (i.e., a length of a longer edge) corresponds to a silver ratio. In other words, W:L=1:\sqrt{2} is satisfied.

With such a shape, even when the print sheet is divided into halves, fourths, eights, sixteenths and so on, the divided print sheets have similar shape to the original print sheet. An international standard of the print sheet is determined based on this shape.

For example, a standard A0 size print sheet has a width of 841 mm and a length of 1189 mm. A standard A1 size print sheet has a width of 594 mm and a length of 841 mm. A standard A2 size print sheet has a width of 420 mm and a length of 594 mm. A standard A3 size print sheet has a width of 297 mm and a length of 420 mm. A standard A4 size print sheet has a width of 210 mm and a length of 297 mm.

The A0 size print sheet is divided into two A1 size print sheets. The length and width of the A1 size print sheet are 1/\sqrt{2} of those of the A0 size print sheet. The A1 size print sheet is divided into two A2 size print sheets. The length and width of the A2 size print sheet are 1/\sqrt{2} of those of the A1 size print sheet. The A2 size print sheet is divided into two A3 size print sheets. The length and width of the A3 size print sheet are 1/\sqrt{2} of those of the A2 size print sheet. The A3 size print sheet is divided into two A4 size print sheets. The length and width of the A4 size print sheet are 1/\sqrt{2} of those of the A3 size print sheet. Further, the A0, A1,A2 and A3 size print sheets have the similar shape.

In order to perform the N-up printing, i.e., to print N pages of the document on a print surface (i.e., the output page) on the print sheet, it is necessary to reduce a length and a width of each page of the document at a suitable reduction ratio. This reduction ratio is determined based on the following equation (1).

Reduction Ratio (%)=100×(1/\sqrt{n}) (1)

Here, “n” is determined by the up-number N of pages of the document printed on the output page of the print sheet. For example, when N is 1 (N=1), n is 1 (n=1). When N is 2 (N=2), n is 2 (n=2). When N is 4 (N=4), n is 4 (n=4). When N is 6 or 8 (N=6 or 8), n is 8 (n=8). When N is 9 (N=9), n is 9 (n=9). When N is 16 (N=16), n is 16 (n=16).

### <Operation>

Next, an operation of the PC 1001 will be described. When the PC 1001 is instructed by the user (i.e., a print operator) to print an intended document, data for identifying the pages of the document 10 is transferred to the control unit 1015. Based on the transmitted data and print settings set by the user, the control unit 1015 creates “page data” to be printed. To be more specific, the control unit 1015 causes the display unit 1012 to display the user interface 1011u shown in FIG. 4. The user performs settings using the dialog box of the user interface 1011u.

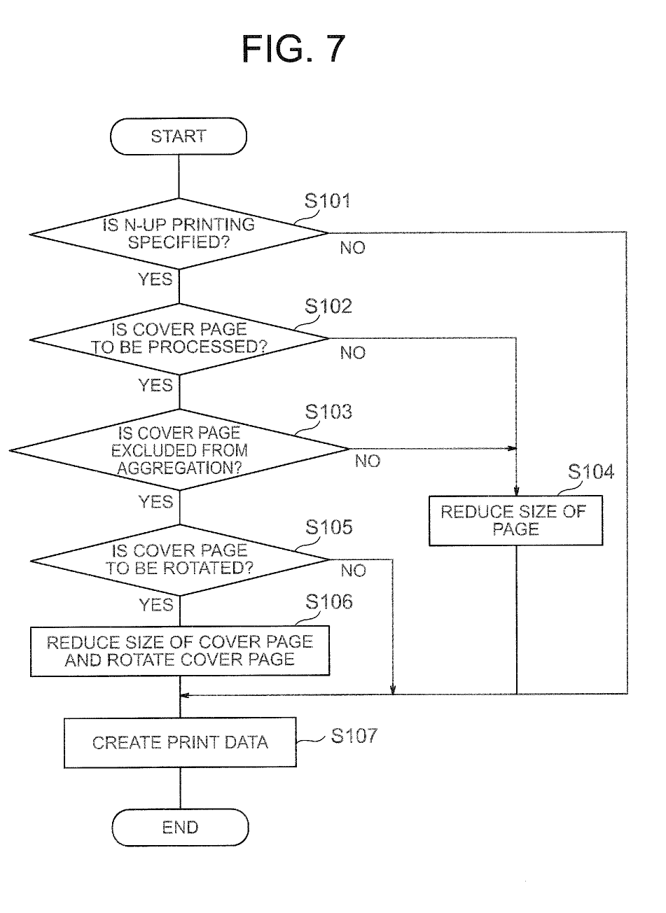

FIG. 7 is a flowchart showing aggregation processing that the control unit 1015 performs based on the page data as described above. The aggregation processing will be described with reference to FIG. 7.

The control unit 1015 checks whether the user specifies the N-up printing (step S101). In this regard, the user specifies the up-number N at the multipage specifying section 1034 of the dialog box of the user interface 1011u (FIG. 4). More specifically, the multipage specifying section 1034 shows a list of choices from a 1-up printing (N=1) to a 16-up printing (N=16) by way of a pull-down menu or the like, and the user chooses one of the choices. FIG. 4 shows a state where the 6-up printing (N=6) is chosen. When a normal printing (i.e., the 1-up printing) is chosen (i.e.; NO in step S101), the control unit 1015 creates a normal print data in which a page of the document is printed in each page on the print sheet (step S107).

When the N-up printing (for example, the 6-up printing) is selected (YES in step S101), the control unit 1015 checks a page number of the document to be processed (step S102). If a page (i.e., the content page) other than the cover page is to be processed (NO in step 102), the control unit 1015 sets the reduction ratio based on the up-number N specified by the user (step S104). Using the reduction ratio, the control unit 1015 reduces the page and creates the print data (step S107). For example, if the 6-up printing is performed on the A4 size print sheet, the reduction ratio is determined by substituting n=8 into the above described equation (1). In this case, the reduction ratio is approximately 35%.

When the cover page (whose page number is 1) is to be processed (YES in step S102), the control unit 1015 checks whether the cover page is specified as an object of the aggregation (step S103). When the user specifies that the cover page is excluded from the object of the aggregation, the user marks (i.e., checks) the checkbox of the cover page exclusion specifying section 1035 shown in FIG. 4. FIG. 4 shows a case where the checkbox of the cover page exclusion specifying section 1035 is marked (checked), i.e., where the cover page is excluded from the object of the aggregation.

When the cover page is specified as the object to the aggregation (NO in step S103), the control unit 1015 sets the reduction ratio based on the up-number N specified by the user (step S104). Using the reduction ratio, the control unit 1015 reduces the cover page and creates print data (step S107). As described above, if the 6-up printing is performed on the A4 size print sheet, the reduction ratio is approximately 35%. In this case, the control unit 1015 creates the print data in which the cover page and the content page(s) are arranged on the same page.

When the cover page is excluded from the object of the aggregation (YES in step S103), the control unit 1015 determines an orientation of the output page based on the orientation of the page of the document 10 and the up-number N specified at the multipage specifying section 1034. Further, the control unit 1015 causes the print orientation display section 1038 (FIG. 4) to display the determined orientation (step S105). When the above described judging unit 1015d judges that it is unnecessary to rotate the cover page (NO in step S105), the control unit 1015 creates print data of the cover page without reducing the size so that the cover page is singly printed on the output page of the print sheet (step S107). When the judging unit 1015d judges that it is necessary to rotate the cover page (YES in step S105), the control unit 1015 rotates the cover page and reduces the size of the cover page so that a longer edge of the cover page becomes shorter or equal to than a shorter edge of the output page of the print sheet as described later (step S106). Then, the control unit 1015 creates print data of the cover page so that the cover page is singly printed on the output page of the print sheet (step S107).

When creation of the whole print data regarding the document 10 is completed, the PC 1001 transmits the created print data to the image forming apparatus 1002 as file data via the communication unit 1014. The image forming apparatus 1002 receives the file data via the communication unit 1022, and performs the N-up printing using the layout specified by the user.

### <Consideration>

Here, a description will be made of a relationship among the orientation of the document 10, the up-number N specified at the multipage specifying section 1034, the orientation of the output page, and the necessity of the rotation of the cover page.

First, a description will be made of the N-up printing of the document 10 oriented in the longitudinal (portrait) orientation as shown in FIG. 5.

When the 2-up printing is to be performed, the user specifies the 2-up printing at the multipage specifying section 1034 (FIG. 4) for the document 10 (FIG. 5), and marks the checkbox of the cover page exclusion specifying section 1035 to exclude the cover page from the aggregation. FIGS. 8A, 8B, 8C and 8D are schematic views for illustrating the layouts of the output pages of the 2-up printing. FIGS. 8A, 8B, 8C and 8D show print screens outputted by the print data creation unit 1015a and printed on the print sheet by the image forming apparatus 1002. As shown in FIGS. 8A, 8B, 8C and 8D, in the 2-up printing, the content pages 10₁ through 10₆ of the document 10 are reduced in size with a predetermined reduction ratio, and at most two content pages are aggregated into one page (i.e., the output page 20a) of the print sheet. In the 2-up printing, the output pages 20a containing aggregated content pages 20₁ through 20₆ are oriented in the lateral (landscape) orientation. Therefore, the print orientation display unit 1038 displays “lateral”.

In this case, if the cover page 10₀ (FIG. 5) of the document 10 is printed without rotating, the orientation of the cover page 10₀ (i.e., the longitudinal orientation as shown in FIG. 5) is different from the orientation of the output pages 20a (containing the aggregated content pages 20₁ through 20₆) by 90 degrees. In this regard, FIG. 20 shows a comparison example when the cover page is printed without rotating. Therefore, in this embodiment, the control unit 1015 rotates the cover page 10₀ of the document 10 by 90 degrees so that a cover page 20₀ (after rotation) is contained in the output page 20a oriented in the lateral orientation. As shown in FIG. 8A, the control unit 1015 creates print data of the cover page 20₀ by reducing the size of the cover page 10₀ so that the longer edge of the cover page 20₀ is shorter than or equal to the shorter edge of the output page 20a of the print sheet. The size of the print sheet (here, A4 size) is specified by the sheet-size specifying section 1032. In this example, the reduction ratio of the cover page 10₀ is set to approximately 70%. The reduction ratio of the content pages 10₁ through 10₆ is approximately 70% according to the above described equation (1).

When the 4-up printing is to be performed, the user specifies the 4-up printing at the multipage specifying section 1034 (FIG. 4) for the document 10 (FIG. 5), and marks the checkbox of the cover page exclusion specifying section 1035 to exclude the cover page from the aggregation. FIGS. 9A, 9B and 9C are schematic views for illustrating the layouts of the output pages of the 4-up printing. FIGS. 9A, 9B and 9C show print screens outputted by the print data creation unit 1015a and printed on the print sheet by the image forming apparatus 1002. As shown in FIGS. 9A, 9B and 9C, in the 4-up printing, the content pages 10₁ through 10₆ of the document 10 are reduced in size with a predetermined reduction ratio, and at most four content pages are aggregated into one page (i.e., the output page 20a) of the print sheet. In this example, among six content pages 10₁ through 10₆, four content pages 10₁ through 10₄ are printed in one output page 20a, and two content pages 10₅ and 10₆ are printed in the next output page 20a. In the 4-up printing, the output pages 20a containing aggregated content pages 20₁ through 20₆ are oriented in the longitudinal (portrait) orientation. Therefore the print orientation display unit 1038 displays “longitudinal”.

In this case, if the cover page 10₀ of the document 10 is printed without rotating, the orientation the cover page 10₀ (i.e., the longitudinal orientation as shown in FIG. 5) becomes the same as the orientation of the output pages 20a containing the aggregated content pages 20₁ through 20₆. Therefore, as shown in FIG. 9A, the control unit 1015 creates print data of a cover page 20₀ without changing the orientation and size of the cover page 10₀. In this example, the reduction ratio of the content pages 10₁ through 10₆ is approximately 50% according to the above described equation (1).

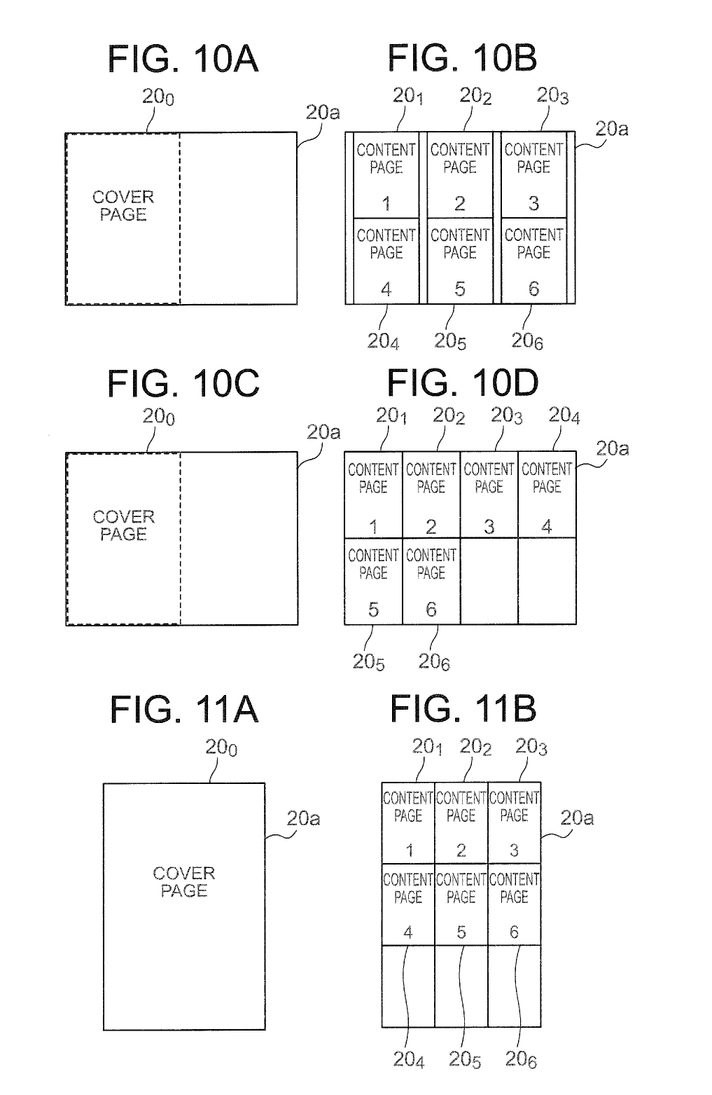

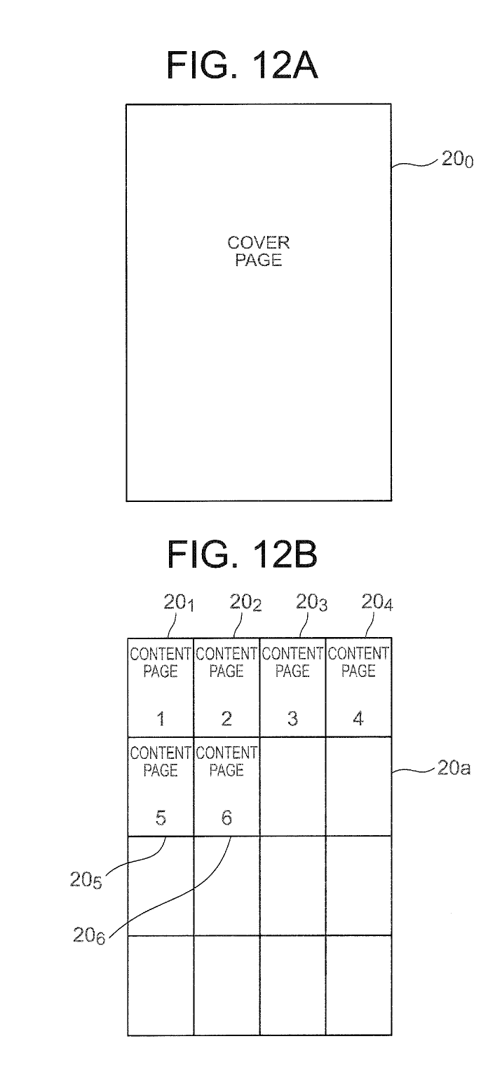

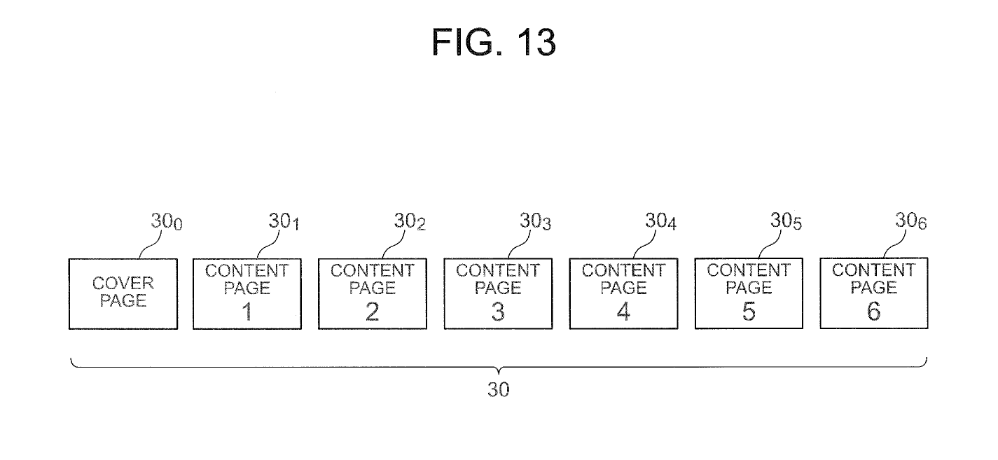

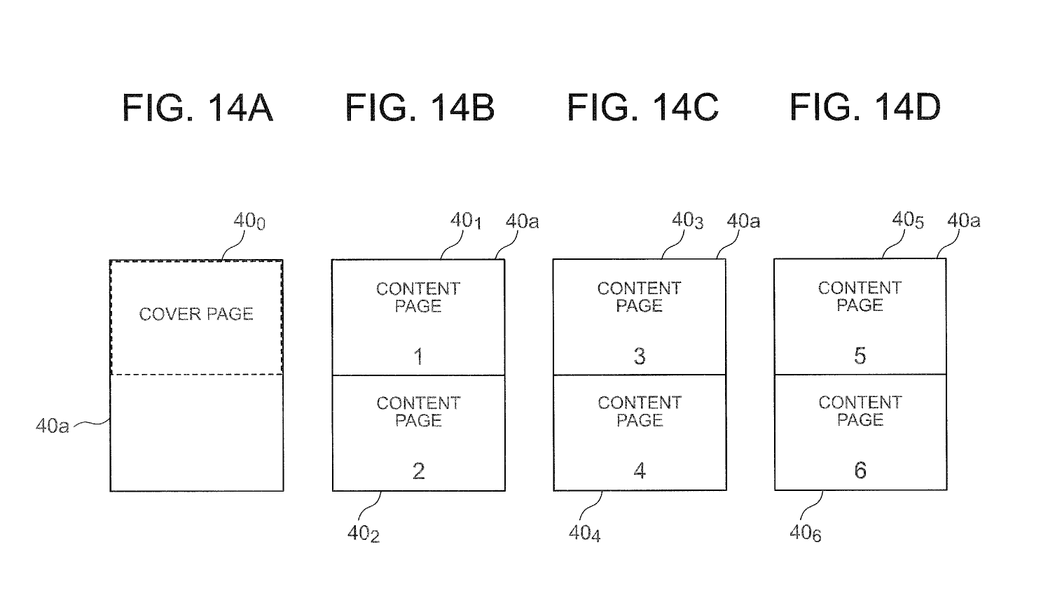

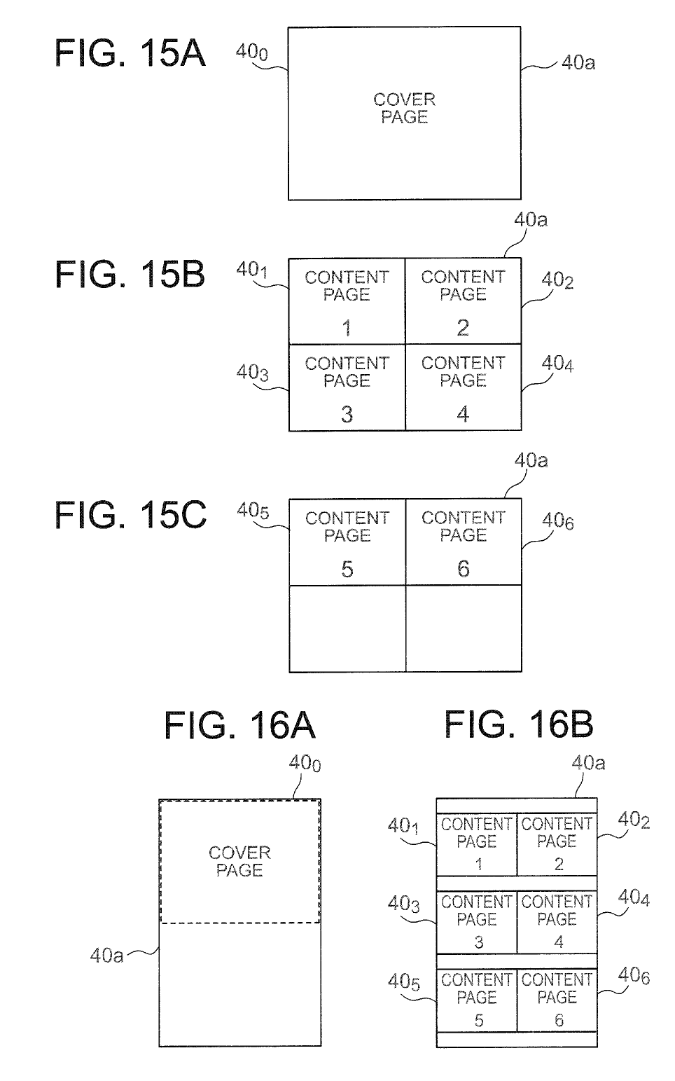

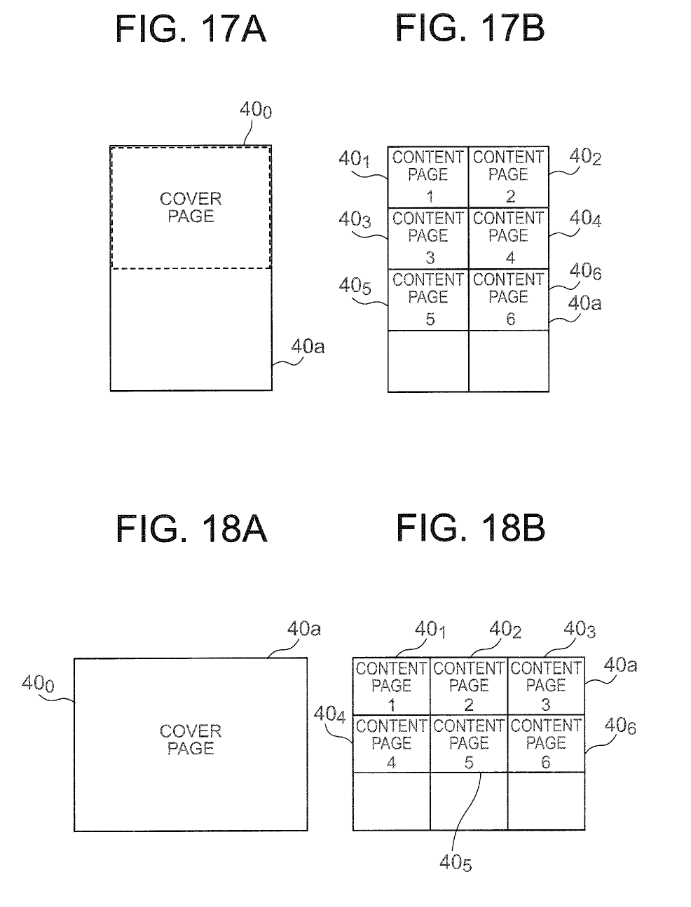

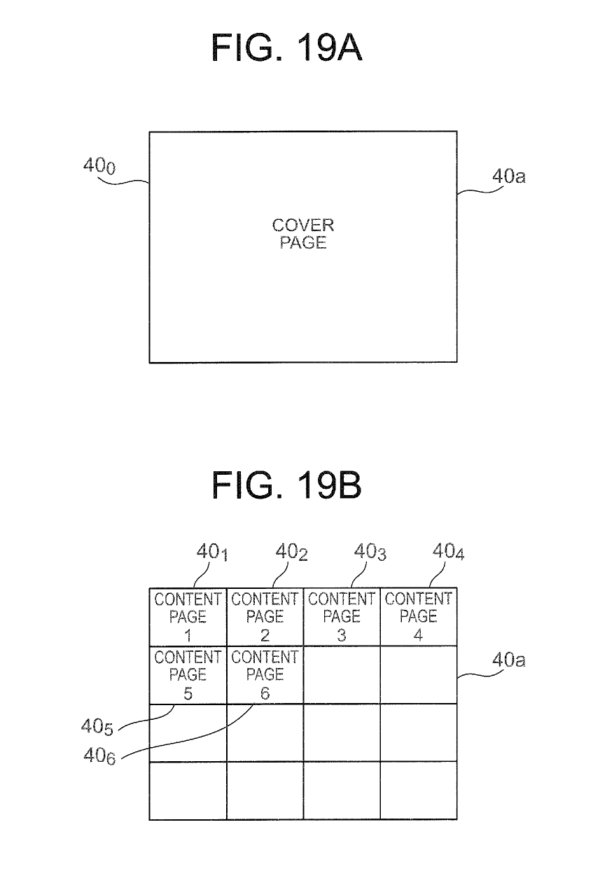

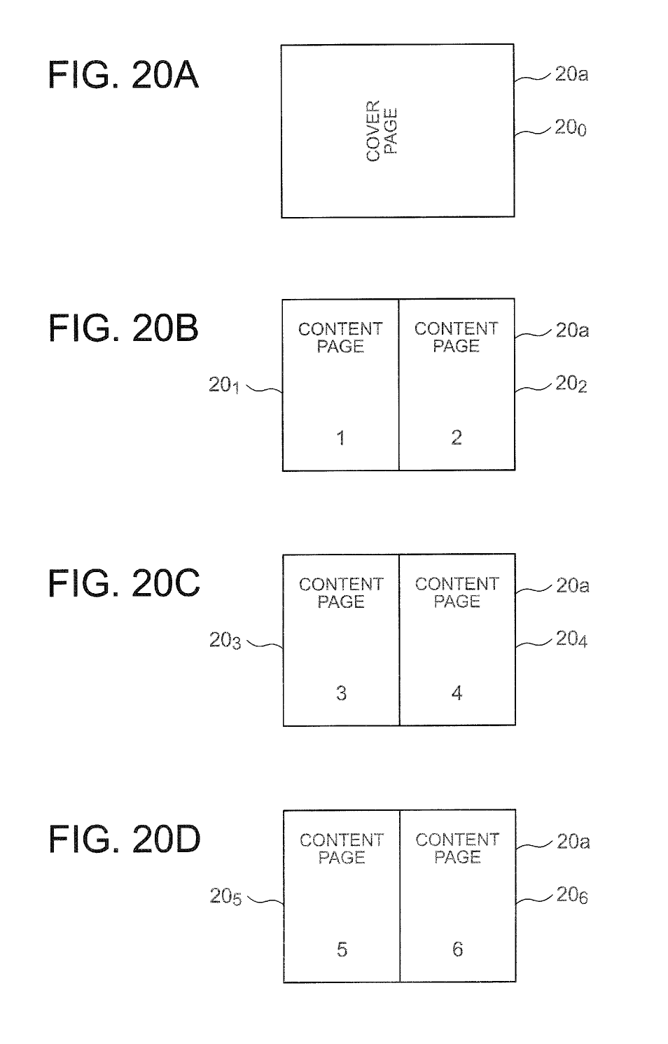

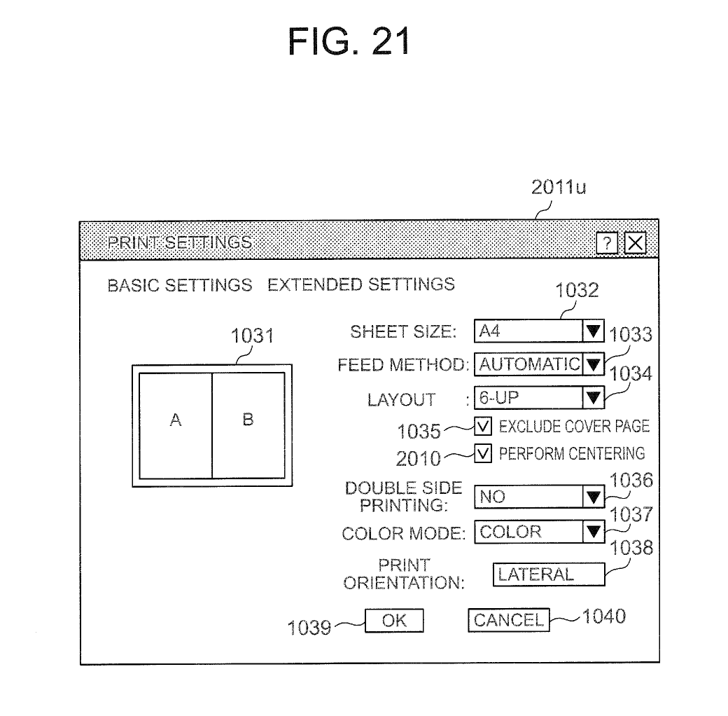

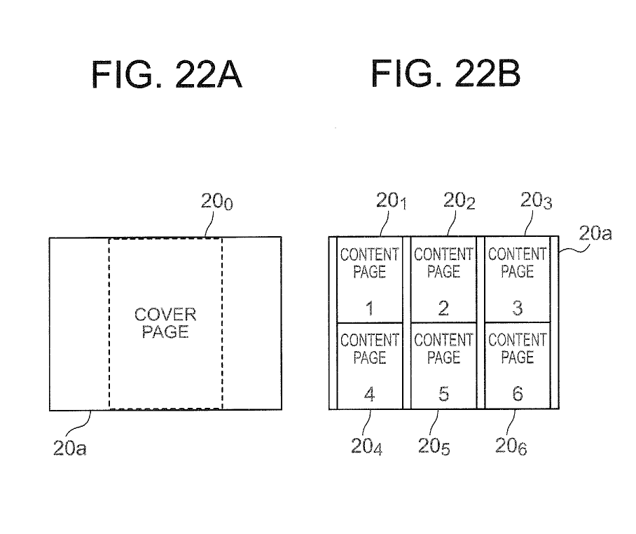

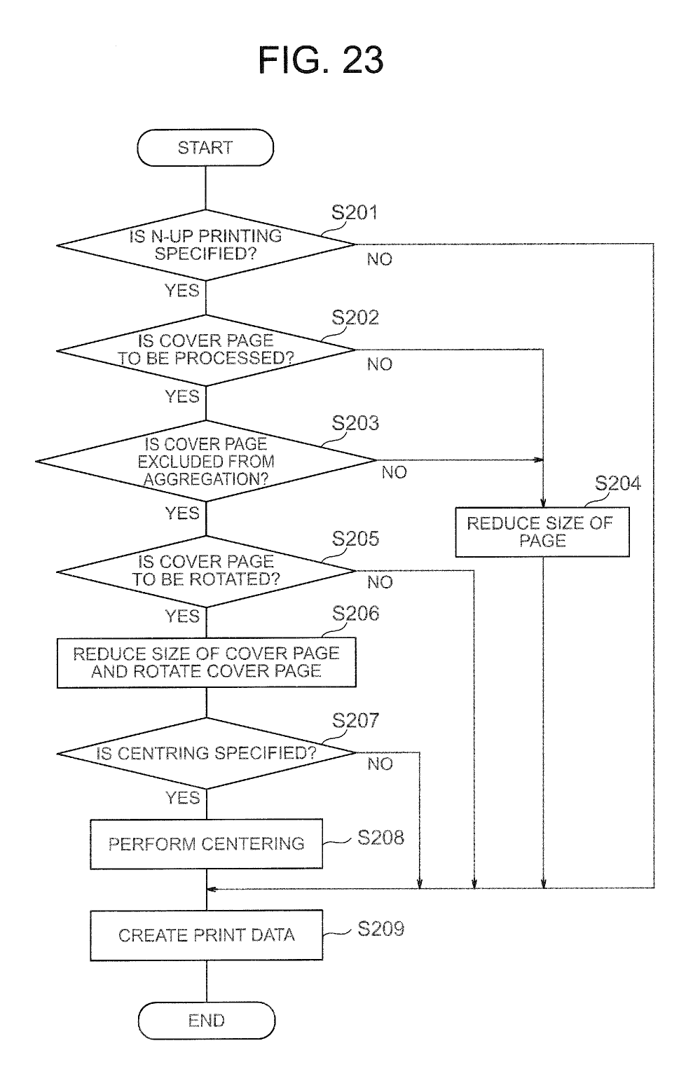

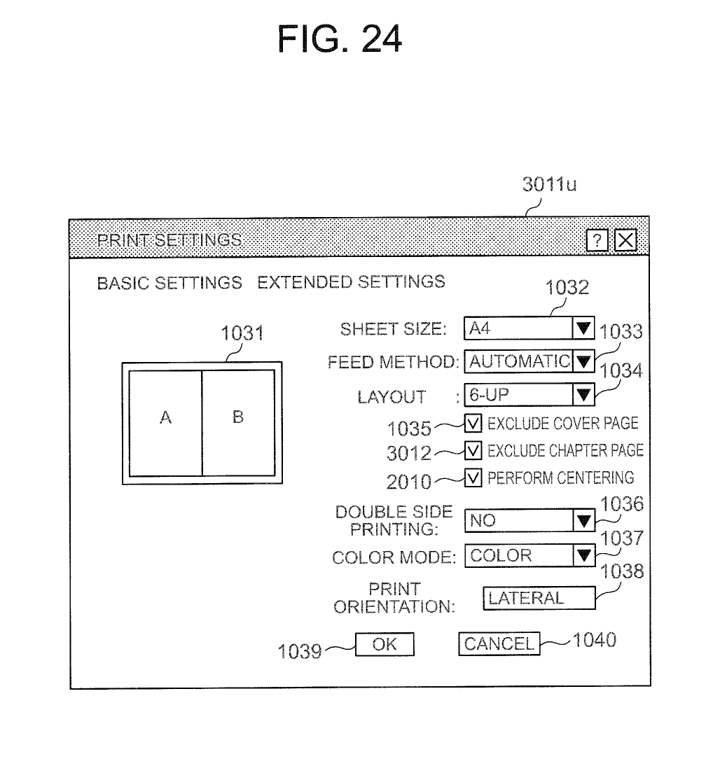

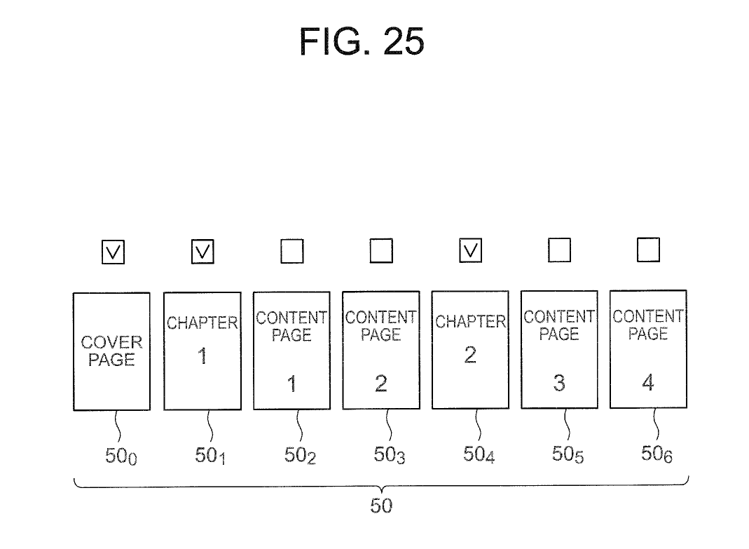

When the 6-up printing is to be performed, the user specifies the 6-up printing at the multipage specifying section 1034 (FIG. 4) for the document 10 (FIG. 5), and marks the checkbox of the cover page exclusion specifying section 1035 to exclude the cover page from the aggregation. FIGS. 10A and 10B are schematic views for illustrating the layouts of the output pages of the 6-up printing. FIGS. 10A and 10B show print screens outputted by the print data creation unit 1015a and printed on the print sheet by the image forming apparatus 1002. As shown in FIGS. 10A and 10B, in the 6-up printing, the content pages 10₁ through 10₆ of the document 10 are reduced in size with a predetermined reduction ratio, and at most six content pages are aggregated into one page (i.e., the output page 20a) of the print sheet. In this 6-up printing, the output pages 20a containing aggregated content pages 20₁ through 20₆ are oriented in the lateral (landscape) orientation. Therefore, the print orientation display unit 1038 displays “lateral”.

In this case, if the cover page 10₀ of the document 10 is printed without rotating, the orientation the cover page 10₀ (i.e., the longitudinal orientation as shown in FIG. 5) becomes different from the orientation of output pages 20a (containing the aggregated content pages 20₁ through 20₆) by 90 degrees. Therefore, the control unit 1015 rotates the cover page 10₀ of the document 10 by 90 degrees so that a cover page 20₀ (after rotation) is contained in the output page 20a oriented in the lateral orientation. As shown in FIG. 10A, the control unit 1015 creates print data of the cover page 20₀ by reducing the size of the cover page 10₀ so that the longer edge of the cover page 20₀ is shorter than or equal to the shorter edge of the output page 20a of the print sheet. The size of the print sheet (here, A4 size) is specified by the sheet-size specifying section 1032. In this example, the reduction ratio of the cover page 10₀ is set to approximately 70%. The reduction ratio of the content pages 10₁ through 10₆ is approximately 35% according to the above described equation (1).

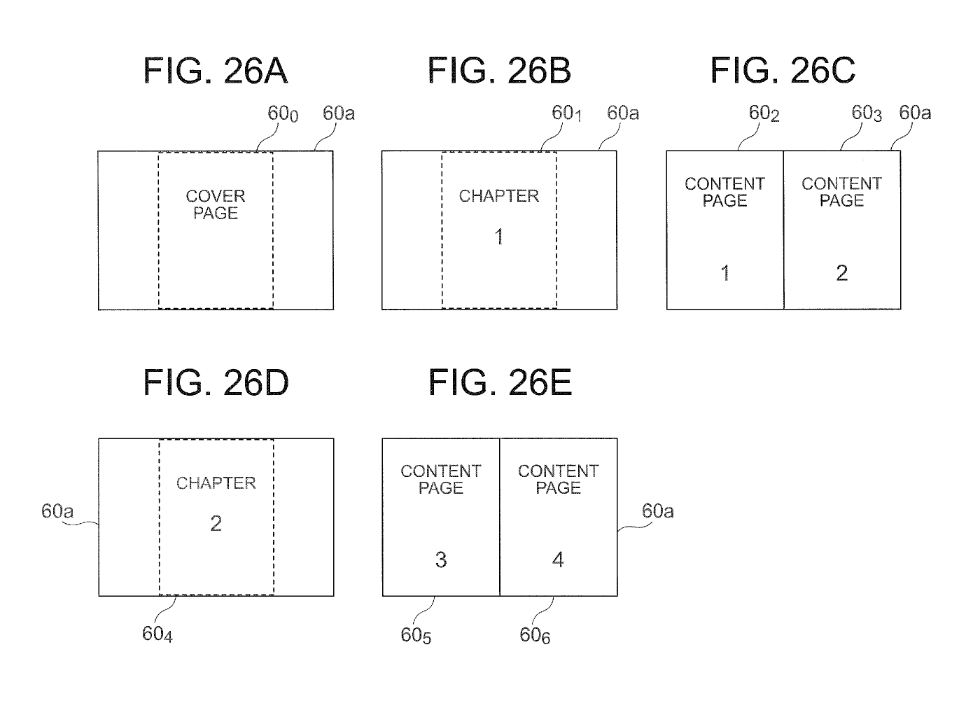

When the 8-up printing is to be performed, the user specifies the 8-up printing at the multipage specifying section 1034 (FIG. 4) for the document 10 (FIG. 5), and marks the checkbox of the cover page exclusion specifying section 1035 to exclude the cover page from the aggregation. FIGS. 10C and 10D are schematic views for illustrating the layouts of the 8-up printing. FIGS. 100 and 10D show print screens outputted by the print data creation unit 1015a and printed on the print sheet by the image forming apparatus 1002. As shown in FIGS. 100 and 10D, in the 8-up printing, the content pages 10₁ through 10₆ of the document 10 are reduced in size with a predetermined reduction ratio, and at most eight content pages (in this example, six content pages) are aggregated into one page (i.e., the output page 20a) of the print sheet. In this 8-up printing, the output pages 20a containing aggregated content pages 20₁ through 20₆ are oriented in the lateral (landscape) orientation. Therefore, the print orientation display unit 1038 displays “lateral”. The cover page is printed in the same manner as in the 6-up printing, and explanation thereof will be omitted.

When the 9-up printing is to be performed, the user specifies the 9-up printing at the multipage specifying section 1034 (FIG. 4) for the document 10 (FIG. 5), and marks the checkbox of the cover page exclusion specifying section 1035 to exclude the cover page from the aggregation. FIGS. 11A and 11B are schematic views for illustrating the layouts of the 9-up printing. FIGS. 11A and 11B show print screens outputted by the print data creation unit 1015a and printed on the print sheet by the image forming apparatus 1002. As shown in FIGS. 11A and 11B, in the 9-up printing, the content pages 10₁ through 10₆ of the document 10 are reduced in size with a predetermined reduction ratio, and at most nine content pages (in this example, six content pages) are aggregated into one page (i.e., the output page 20a) of the print sheet. In this 9-up printing, the output pages 20a containing aggregated content pages 20₁ through 20₆ are oriented in the longitudinal (portrait) orientation. Therefore, the print orientation display unit 1038 displays “longitudinal”.

In this case, if the cover page 10₀ of the document 10 is printed without rotating, the orientation of the cover page 10₀ (i.e., the longitudinal orientation as shown in FIG. 5) becomes the same as the orientation of the output pages 20a containing the aggregated content pages 20₁ through 20₆. Therefore, as shown in FIG. 11A, the control unit 1015 creates print data of a cover page 20₀ without changing the orientation and size of the cover page 10₀. In this example, the reduction ratio of the content pages 10₁ through 10₆ is approximately 33% according to the above described equation (1).

When the 16-up printing is to be performed, the user specifies the 16-up printing at the multipage specifying section 1034 (FIG. 4) for the document 10 (FIG. 5), and marks the checkbox of the cover page exclusion specifying section 1035 to exclude the cover page from the aggregation. FIGS. 12A and 12B are schematic views for illustrating the layouts of the 16-up printing. FIGS. 12A and 12B show print screens outputted by the print data creation unit 1015a and printed on the print sheet by the image forming apparatus 1002. As shown in FIGS. 12A and 12B, in the 16-up printing, the content pages 10₁ through 10₆ of the document 10 are reduced in size with a predetermined reduction ratio, and at most sixteen content pages (in this example, six content pages) are aggregated into one page (i.e., the output page 20a) of the print sheet. In this 16-up printing, the output pages 20a containing aggregated content pages 20₁ through 20₆ are oriented in the longitudinal (portrait) orientation. Therefore, the print orientation display unit 1038 displays “longitudinal”. In this case, if the cover page 10₀ of the document 10 is printed without rotating, the orientation of the cover page 10₀ (i.e., the longitudinal orientation as shown in FIG. 5) becomes the output pages 20a containing the aggregated content pages 20₁ through 20₆. Therefore, as shown in FIG. 12A, the control unit 1015 creates print data of a cover page 20₀ without changing the orientation and size of the cover page 10₀. In this example, the reduction ratio of the content pages 10₁ through 10₆ is approximately 25% according to the above described equation (1).

Next, a description will be made of an N-up printing of the document oriented in the lateral (landscape) orientation as shown in FIG. 13.

When the 2-up printing is to be performed, the user specifies the 2-up printing at the multipage specifying section 1034 (FIG. 4) for the document 30 (FIG. 5), and marks the checkbox of the cover page exclusion specifying section 1035 to exclude the cover page from the aggregation. FIGS. 14A, 14B, 14C and 14D are schematic views for illustrating the layouts of the 2-up printing. FIGS. 14A, 14B, 14C and 14D show print screens outputted by the print data creation unit 1015a and printed on the print sheet by the image forming apparatus. 1002. As shown in FIGS. 14A, 14B, 14C and 14D, in the 2-up printing, the content. pages 30₁ through 30₆ of the document 30 are reduced in size with a predetermined reduction ratio, and at most two content pages are aggregated into one page (i.e., the output page 40a) of the print sheet. In this 2-up printing, the output pages 40a containing aggregated content pages 40₁ through 40₆ are oriented in the longitudinal (portrait) orientation. Therefore, the print orientation display unit 1038 displays “longitudinal”. In this case, if the cover page 30₀ of the document 30 is printed without rotating, the orientation of the cover page 30₀ (i.e., the lateral orientation as shown in FIG. 13) becomes different from the orientation of the output pages 40a (containing the aggregated content pages 40₁ through 40₆) by 90 degrees. Therefore, the control unit 1015 rotates the cover page 30₀ of the document 30 by 90 degrees so that a cover page 40₀ (after rotation) is contained in the output page 40a oriented in the longitudinal orientation. As shown in FIG. 14A, the control unit 1015 creates print data of the cover page 40₀ by reducing the size of the cover page 30₀ so that the longer edge of the cover page 40₀ is shorter than or equal to the shorter edge of the output page 40a of the print sheet. The size of the print sheet (here, A4 size) is specified by the sheet-size specifying section 1032. In this example, the reduction ratio of the cover page 30₀ is set to approximately 70%. The reduction ratio of the content pages 30₁ through 30₆ is approximately 70% according to the above described equation (1).

When the 4-up printing is to be performed, the user specifies the 4-up printing at the multipage specifying section 1034 (FIG. 4) for the document 30 (FIG. 13), and marks the checkbox of the cover page exclusion specifying section 1035 to exclude the cover page from the aggregation. FIGS. 15A, 15B and 15C are schematic views for illustrating the layouts of the 4-up printing. FIGS. 15A, 15B and 15C show print screens outputted by the print data creation unit 1015a and printed on the print sheet by the image forming apparatus 1002. As shown in FIGS. 15A, 15B and 15C, in the 4-up printing, the content pages 30₁ through 30₆ of the document 30 are reduced in size with a predetermined reduction ratio, and at most four content pages are aggregated into one page (i.e., the output page 40a) of the print sheet. In this example, among six content pages 30₁ through 30₆, four content pages 30₁ through 30₄ are printed in one output page 40a, and two content pages 30₅ and 30₆ are printed in the next output page 40a. In this 4-up printing, the output pages 40a containing aggregated content pages 40₁ through 40₆ are oriented in the lateral (landscape) orientation. Therefore, the print orientation display unit 1038 displays “lateral”.

In this case, if the cover page 30₀ of the document 30 is printed without rotating, the orientation the cover page 30₀ (i.e., the lateral orientation as shown in FIG. 13) becomes the same as the orientation of the output pages 40a containing the aggregated content pages 40₁ through 40₆. Therefore, as shown in FIG. 15A, the control unit 1015 creates print data of a cover page 40₀ without changing the orientation and size of the cover page 40₀. In this example, the reduction ratio of the content pages 30₁ through 30₆ is approximately 50% according to the above described equation (1).

When the 6-up printing is to be performed, the user specifies the 6-up printing at the multipage specifying section 1034 (FIG. 4) for the document 30 (FIG. 13), and marks the checkbox of the cover page exclusion specifying section 1035 to exclude the cover page from the aggregation. FIGS. 16A and 16B are schematic views for illustrating the layouts of the 6-up printing. FIGS. 16A and 16B show print screens outputted by the print data creation unit 1015a and printed on the print sheet by the image forming apparatus 1002. As shown in FIGS. 16A and 16B, in the 6-up printing, the content pages 30₁ through 30₆ of the document 30 are reduced in size with a predetermined reduction ratio, and at most six content pages are contained in one page (i.e., the output page 40a) of the print sheet. In this 6-up printing, the output pages 40a containing aggregated content pages 40₁ through 40₆ are oriented in the longitudinal (portrait) orientation. Therefore, the print orientation display unit 1038 displays “longitudinal”.

In this case, if the cover page 30₀ of the document 30 is printed without rotating, the orientation of the cover page 30₀ (i.e., the lateral orientation as shown in FIG. 13) becomes different from the orientation of output pages 40a (containing the aggregated content pages 40₁ through 40₆) by 90 degrees. Therefore, the control unit 1015 rotates the cover page 30₀ of the document 30 by 90 degrees so that a cover page 40₀ (after rotation) is contained in the output page 40a oriented in the longitudinal orientation. In FIG. 16A, the control unit 1015 creates print data of the cover page 40₀ by reducing the size of the cover page 30₀ so that the longer edge of the cover page 40₀ is shorter than or equal to the shorter edge of the output page 40a of the print sheet. The size of the print sheet (here, A4 size) is specified by the sheet-size specifying section 1032. In this example, the reduction ratio of the cover page 30₀ is set to approximately 70%. In this example, the reduction ratio of the content pages 30₁ through 30₆ is approximately 35% according to the above described equation (1).

When the 8-up printing is to be performed, the user specifies the 8-up printing at the multipage specifying section 1034 (FIG. 4) for the document 30 (FIG. 13), and marks the checkbox of the cover page exclusion specifying section 1035 to exclude the cover page from the aggregation. FIGS. 17A and 17B are schematic views for illustrating the layouts of the 8-up printing. FIGS. 17A and 17B show print screens outputted by the print data creation unit 1015a and printed on the print sheet by the image forming apparatus 1002. As shown in FIGS. 17A and 17B, in the 8-up printing, the content pages 30₁ through 30₆ of the document 30 are reduced in size with a predetermined reduction ratio, and at most eight content pages are contained in one page (i.e., the output page 40a) of the print sheet. In this 8-up printing, the output pages 40a containing aggregated content pages 40₁ through 40₆ are oriented in the longitudinal (portrait) orientation. Therefore, the print orientation display unit 1038 displays “longitudinal”.

In this case, if the cover page 30₀ of the document 30 is printed without rotating, the orientation of the cover page 30₀ (i.e., the lateral orientation as shown in FIG. 13) becomes different from the orientation of output pages 40a (containing the aggregated content pages 40₁ through 40₆) by 90 degrees. Therefore, the control unit 1015 rotates the cover page 30₀ of the document 30 by 90 degrees so that a cover page 40₀ (after rotation) is contained in the output page 40a oriented in the longitudinal orientation. As shown in FIG. 17A, the control unit 1015 creates print data of the cover page 40₀ by reducing the size of the cover page 30₀ so that the longer edge of the cover page 40₀ is shorter than or equal to the shorter edge of the output page 40a of the print sheet. The size of the print sheet (here, A4 size) is specified by the sheet-size specifying section 1032. In this example, the reduction ratio of the cover page 30₀ is set to approximately 70%. The reduction ratio of the content pages 30₁ through 30₆ is approximately 35% according to the above described equation (1).

When the 9-up printing is to be performed, the user specifies the 9-up printing at the multipage specifying section 1034 (FIG. 4) for the document 30 (FIG. 13), and marks the checkbox of the cover page exclusion specifying section 1035 to exclude the cover page from the aggregation. FIGS. 18A and 18B are schematic views for illustrating the layouts of the 9-up printing. FIGS. 18A and 18B show print screens outputted by the print data creation unit 1015a and printed on the print sheet by the image forming apparatus 1002. As shown in FIGS. 18A and 18B, in the 9-up printing, the content pages 30₁ through 30₆ of the document 30 are reduced in size with a predetermined reduction ratio, and at most nine content pages (in this example, six content pages) are aggregated into one page (i.e., the output page 40a) of the print sheet. In this 9-up printing, the output pages 40a containing aggregated content pages 40₁ through 40₆ are oriented in the lateral (landscape) orientation. Therefore, the print orientation display unit 1038 displays “lateral”.

In this case, if the cover page 30₀ of the document 30 is printed without rotating, the orientation of the cover page 30₀ (i.e., the lateral orientation as shown in FIG. 13) becomes the same as the orientation of the output pages 40a containing the aggregated content pages 40₁ through 40₆. Therefore, as shown in FIG. 18A, the control unit 1015 creates print data of a cover page 40₀ without changing the orientation and size of the cover page 30₀. In this example, the reduction ratio of the content pages 30₁ through 30₆ is approximately 33% according to the above described equation (1).

When the 16-up printing is to be performed, the user specifies the 16-up printing at the multipage specifying section 1034 (FIG. 4) for the document 30 (FIG. 13), and marks the checkbox of the cover page exclusion specifying section 1035 to exclude the cover page from the aggregation. FIGS. 19A and 19B are schematic views for illustrating the layouts of the 16-up printing. FIGS. 19A and 19B show print screens outputted by the print data creation unit 1015a and printed on the print sheet by the image forming apparatus 1002. As shown in FIGS. 19A and 19B, in the 16-up printing, the content pages 30₁ through 30₆ of the document 30 are reduced in size with a predetermined reduction ratio, and at most sixteen content pages (in this example, six content pages) are aggregated into one page (i.e., the output page 40a) of the print sheet. In this 16-up printing, the output pages containing aggregated content pages 40₁ through 40₆ are oriented in the lateral (landscape) orientation. Therefore, the print orientation display unit 1038 displays “lateral”.

In this case, if the cover page 30₀ of the document 30 is printed without rotating, the orientation of the cover page 30₀ (i.e., the lateral orientation as shown in FIG. 13) becomes the same as the orientation of output pages 40a containing the aggregated content pages 40₁ through 40₆. Therefore, as shown in FIG. 19A, the control unit 1015 creates print data of a cover page 40₀ without changing the orientation and size of the cover page 30₀. In this example, the reduction ratio of the content pages 30₁ through 30₆ is approximately 25% according to the above described equation (1).

The above described equation (1) is so set that optimum reduction can be performed in the above described 2-up to the 16-up printings.

### <Advantages>

The image processing apparatus (i.e., the PC 1001) performs the above aggregation process, and therefore the following advantages can be obtained.

The specific page of the document (for example, the cover page) can be excluded from the object of the aggregation.

The orientation of the specific page (for example, the cover page) excluded from the object of the aggregation is the same as the orientation of the aggregated pages (for example, the content pages) irrespective of the up-number N.

In the case where the up-number N is greater than 2 (in a particular example, greater than or equal to 4), even when the size of the specific page (i.e., the cover page) is reduced to change the print orientation, the reduction ratio is higher (i.e., closer to 1) than the aggregated pages. In a particular embodiment, the reduction ratio of the specific page (i.e., the cover page) is approximately 70%.

As described above, according to Embodiment 1 of the present invention, when the N-up printing is performed, the specific page (for example, the cover page) can be excluded from the object of the aggregation. Further, the orientation of the specific page is the same as the orientation of the aggregated pages (for example, the content pages). Moreover, the specific page is not aggregated more than necessary. Therefore, even when the N-up printing is performed, the readability of the specific page is not degraded.

### Embodiment 2

FIG. 21 is a schematic view showing a user interface 2011u displayed by a PC (i.e., an image processing apparatus) according to Embodiment 2 of the present invention. The PC 1001 (see FIG. 1) of Embodiment 2 is different from the PC 1001 of the Embodiment 1 in that a control unit 1015 (corresponding to the control unit 1015 of FIG. 1) of the PC 1001 of Embodiment 2 further performs adjustment (for example, centering) of a position of the specific page. Explanations of components which are the same as those of Embodiment 1 will be omitted. The following explanation will be focused on the difference from Embodiment 1.

As shown in FIG. 21, the user interface 2011u includes a sheet-size specifying section 1032, a feed method specifying section 1033, a multipage specifying section 1034, a cover page exclusion specifying section 1035, a position adjustment specifying section 2010, a double-side printing specifying section 1036 and a color/monochrome specifying section 1037. The sheet-size specifying section 1032 is provided for selecting a size of the print sheet (i.e., the print medium). The feed method specifying section 1033 is provided for specifying a position (i.e., a cassette or tray) from which the print sheet is to be fed. The multipage specifying section 1034 is provided for specifying the up-number N which is used to determine a layout of the aggregated pages on the output page. The cover page exclusion specifying section 1035 is provided for specifying whether or not to exclude the cover page from the aggregation when the N-up printing is performed. The position adjustment specifying section 2010 is provided for specifying whether or not to adjust a position of the cover page (i.e., the specific page) when the cover page is excluded from the aggregation. The double-side printing specifying section 1036 is provided for specifying whether or not to perform a double-side printing. The color/monochrome specifying section 1037 is provided for selecting one of a color printing and a monochrome printing.

A preview display section 1031 displays a simplified image based on settings at the specifying sections 1032 through 1037.

A print orientation display section 1038 automatically displays an orientation of the output page, i.e., “longitudinal” (portrait) or “lateral” (landscape) based on the number N (i.e., the up-number) specified at the multipage specifying section 1034. Further, an OK button 1039 and a cancel button 1040 are provided for confirming and cancelling the settings specified at the sections 1032 through 1037 and 2010.

FIG. 23 is a flowchart showing aggregation processing that the control unit 1015 of Embodiment 2 performs based on the settings set by the user. The aggregation processing will be described with reference to FIG. 23. The steps S201 through S206 and step S209 are the same as those of the steps S101 through S107 described with reference to FIG. 7, and therefore an outline thereof will be described.

When the cover page is excluded from an object of the N-up printing (YES in step S203), the control unit 1015 determines an orientation of the output page based on the orientation of the page of the document 10 and the up-number N specified at the multipage specifying section 1034. Further, the control unit 1015 causes the print orientation display section 1038 of the dialog box shown in FIG. 21 to display the determined orientation (step S205). When the judging unit 1015d (FIG. 1) judges that it is unnecessary to rotate the cover page (NO in step S205), the control unit 1015 creates print data of the cover page without reducing the size so that the cover page is singly printed on a page of the output page of the print sheet (step S209). When the judging unit 1015d judges that it is necessary to rotate the cover page (YES in step S205), the control unit 1015 rotates the cover page and reduces the size of the cover page so that the longer edge of the cover page becomes shorter than or equal to the shorter edge of the output page of the print sheet as described above (step S206).

When the cover page is reduced in size in the step S206, the control unit 1015 checks whether a position adjustment is selected at the position adjustment specifying section 2010 (step S207). When the user is going to specify the position adjustment of the specific page, the user marks a checkbox of the position adjustment specifying section 2010 of the dialog box of the user interface 2011u shown in FIG. 21. FIG. 21 shows a state where the checkbox of the position adjustment specifying section 2010 is marked.

When the position adjustment is not specified at the position adjustment specifying section 2010 (NO in step S207), the control unit 1015 creates print data in which the cover page 20₀ (shown by a broken line in FIG. 10A) is singly formed on the output page of the print sheet. The cover page 20₀ is reduced in size and is located so that a base position of the cover page 20₀ is set to an origin (i.e., a bottom-left corner) of the output page of the print sheet as shown in FIG. 10A (step S209). In contrast, when the position adjustment is selected at the position adjustment specifying section 2010 (YES in step S207), the control unit 1015 creates print data by adjusting the position of the cover page 20₀ (shown by a broken line in FIG. 22A) at a center position of the output page of the print sheet as shown in FIG. 22A (step S208). In this regard, an adjusting amount (i.e., a shifting amount) of the cover page 20₀ is determined based on a length of the longer edge of the output page 20a of the print sheet and a length of the shorter edge of the cover page 20₀.

When creation of the whole print data regarding the document is completed, the PC 1001 transmits the created print data to the image forming apparatus 1002 as file data via the communication unit 1014. The image forming apparatus 1002 receives the file data via the communication unit 1002, and performs the N-up printing using the layout specified by the user.

In the above description, the checkbox of the position adjustment specifying section 2010 is used to determine whether or not to perform the position adjustment of the specific page.

However, it is also possible to provide a combo-box or the like to allow the user to specify one of a plurality of choices (for example, right, center or left). It is also possible to use an edit box or the like to allow the user to numerically specify the position of the specific page.

As described above, according to Embodiment 2 of the present invention, when the N-up printing is performed, the specific page (for example, the cover page) can be excluded from the object of the aggregation. Further, the orientation of the specific page is the same as the orientation of the aggregated pages (for example, the content pages). Moreover, the specific page is not aggregated more than necessary. Therefore, even when the N-up printing is performed, the readability of the specific page is not degraded. Additionally, when the specific page (i.e., the cover page) is reduced in size, the position of the specific page is adjusted to a desired position. Therefore, the specific page with a better appearance can be obtained.

### Embodiment 3

FIG. 24 is a schematic view showing a user interface 3011u displayed by a PC 1001 (i.e., an image processing apparatus) according to Embodiment 3 of the present invention. FIG. 25 is a schematic view showing a display screen including a 7-page document (including a cover page, chapter pages, and content pages) displayed on a display unit 1012 according to Embodiment 3.

The PC 1001 of Embodiment 3 is different from the PC of the Embodiment 2 in that a control unit 1015 (corresponding to the control unit 1015 of FIG. 1) of the PC 1001 of Embodiment 3 further performs processing to exclude the chapter pages from the object of the aggregation. Explanations of components which are the same as those of Embodiment 1 or 2 will be omitted. The following explanation will be focused on the difference from Embodiment 1 or 2.

As shown in FIG. 24, the user interface 3011u includes a sheet-size specifying section 1032, a feed method specifying section 1033, a multipage specifying section 1034, a cover page exclusion specifying section 1035, a chapter page exclusion specifying section 3012, a position adjustment specifying section 2010, a double-side printing specifying section 1036 and a color/monochrome specifying section 1037. The sheet-size specifying section 1032 is provided for selecting a size of the print sheet. The feed method specifying section 1033 is provided for specifying a position (i.e., a cassette or tray) from which the print sheet is to be fed. The multipage specifying section 1034 is provided for specifying the up-number N which is used to determine a layout of the aggregated pages on the output page. The cover page exclusion specifying section 1035 is provided for specifying whether or not to exclude the cover page from the aggregation when the N-up printing is performed. The chapter page exclusion specifying section 3012 is provided for specifying whether or not to exclude the chapter page(s) from the aggregation when the N-up printing is performed. The position adjustment specifying section 2010 is provided for specifying whether or not to adjust positions of the cover page and the chapter page(s) when the cover page and the chapter page(s) are excluded from the aggregation. The double-side printing specifying section 1036 is provided for specifying whether or not to perform a double-side printing. The color/monochrome specifying section 1037 is provided for selecting one of a color printing and a monochrome printing.

A preview display section 1031 displays a simplified image based on settings at the specifying sections 1032 through 1037. A print orientation display section 1038 automatically displays an orientation of the output page, i.e., “longitudinal” or “lateral” based on the number N (i.e., the up-number) specified at the multipage specifying section 1034. Further, an OK button 1039 and a cancel button 1040 are provided for confirming and cancelling the settings specified at the sections 1032 through 1037, 2010 and 3012.

In this regard, the term “chapter page” is used to indicate a page containing an indication of a chapter (for example, a chapter number).

When the user is going to perform the N-up printing of the document 50 (FIG. 25), and to exclude the cover page 50₀ and the chapter pages 50₁ and 50₄ from the object of the aggregation, the user marks checkboxes of the cover page exclusion specifying section 1035 and the chapter page exclusion specifying section 3012 of the dialog box of the user interface 3011u shown in FIG. 24.

When the checkbox of the chapter page exclusion specifying. section 3012 is marked, the control unit 1015 causes the display unit 1012 to display a choice screen as shown in FIG. 25. The choice screen of FIG. 25 includes checkboxes corresponding to the respective pages 50₀ through 50₆ of the document 50. The choice screen allows the user to choose the chapter page(s) to be excluded from the object of the aggregation.

When the user marks the checkbox of the choice screen of FIG. 25, the chapter pages corresponding to the chosen checkboxes are excluded from the object of the aggregation. In this regard, if the user marks the checkbox of the cover page exclusion specifying section 1035 of the dialog box of FIG. 24, the check box corresponding to the cover page 50₀ in the choice screen of FIG. 25 is automatically marked.

When the print settings are completed, and when the specific pages (here, the cover page 50₀ and the chapter pages 50₁ and 50₄) are set to be excluded from the aggregation, the control unit 1015 creates the print data in substantially the same manner as described with reference FIG. 23 in Embodiment 2. In step S202 and S203, when the page to be processed is the specific page (YES in step S202), the control unit 1015 checks whether the specific page is specified as the object of the aggregation (step S203).

FIGS. 26A, 26B, 26C, 26D and 26E are schematic view showing layouts of the output pages 60a of the N-up printing. Here, the 2-up printing is specified at the multipage specifying section 1034, and the position adjustment of the cover page 50₀ is specified at the position adjustment specifying section 2010. In this case, as shown in FIG. 26C and 26E, the content pages 50₂, 50₃, 50₅ and 50₆ are reduced in size. The content pages 50₂ and 50₃ are aggregated into one pate (i.e., the output page 60a) of the print sheet, and the content pages 50₅ and 50₆ are aggregated into another page (i.e., the output page 60a) of the print sheet.

The output pages 60a containing aggregated content pages 60₂, 60₃, 60₅ and 60₆ are oriented in the lateral orientation.

In this regard, if the specific pages (i.e., the cover page 50₀ and the chapter pages 50₁ and 50₄) of the document 50 are printed without rotating, the orientation of the specific pages (i.e., the longitudinal orientation as shown in FIG. 25) becomes different from the orientation of the output pages 60a containing the aggregated content pages 60₂, 60₃, 60₅ and 60₆ (i.e., the lateral orientation). Therefore, the control unit 1015 rotates the specific pages (i.e., the cover page 50₀ and the chapter pages 50₁ and 50₉) of the document 10 by 90 degrees so that the specific pages are contained in the output pages 60a oriented in the ,lateral orientation. The control unit 1015 creates print data of specific pages 60₀, 60₁ and 60₄ by reducing the size of the specific pages (i.e., the cover page 50₀ and the chapter pages 50₁ and 50₄) so that the longer edges of the specific pages 60₀, 60₁ and 60₄ are shorter than the shorter edges of the output pages 60a of the print sheet. The size of the print sheet (here, A4 size) is specified by the sheet-size specifying section 1032.

In this example, the reduction ratio of the specific page is set to approximately 70%. The reduction ratio of the content pages 50₂, 50₃, 50₅ and 50₆ is approximately 70% according to the above described equation (1). Further, since the position adjustment of the specified pages is selected, the specific pages 60₀, 60₁ and 60₄ enclosed by broken lines are adjusted to center positions of the pages of the print sheet.

As described above, according to Embodiment 3 of the present invention, when the N-up printing is performed, the specific pages (for example, the cover page and the chapter page) can be excluded from the object of the aggregation. Further, the orientation of the specific pages is the same as the orientation of the aggregated pages (for example, the content pages). Moreover, the specific pages are not aggregated more than necessary. Therefore, even when the N-up printing is performed, the readability of the specific pages is not degraded. In addition, whet the specific pages are reduced in size, the positions of the specific pages are adjusted to desired positions. Therefore, the specific pages (i.e., the cover page and the chapter page) with a better appearance can be obtained.

In the third embodiment, the cover page and the chapter page are specified as the specific pages. However, it is possible to specify only the chapter page as the specific page. Further, it is also possible to specify the first page (that may be or may not be the same as the cover page) of the document as the specific page. Further, it is possible to specify any combination of the cover page, the chapter page(s) and the first page as the specific page.

In the above described embodiments, the PC 1001 has the control unit 1015 and the program 1011a having the functions described in Embodiments 1, 2 or 3. However, the present invention is not limited to such examples. It is also possible that the image forming apparatus 1002 has a part or the whole of the functions of the control unit 1015 and the program 1011a.

Further, in the above described embodiments, the image forming apparatus 1002 prints images of the document on the print sheets. However, the present invention is not limited to such examples. The present invention is also applicable to an apparatus and a method outputting data such as PDF (Portable Document Format). Even in such case, advantages described in Embodiments 1, 2 and 3 can be obtained.

Further, it is also possible to convert a document of a certain file format into another file format, electronically output the converted file, and store the file in the storage unit 1011 as the data 1011d.

While the preferred embodiments of the present invention have been illustrated in detail, it should be apparent that modifications and improvements may be made to the invention without departing from the spirit and scope of the invention as described in the following claims.

What is claimed is:

1. An image processing apparatus comprising:
a control unit that processes a plurality of pages by aggregating a certain number of pages among the plurality of pages into an output page, and
a specifying unit that specifies a specific page among the plurality of pages and excludes the specific page from an object of the aggregation by the control unit,
wherein when an orientation of the specific page is different from an orientation of the output page containing aggregated pages, the control unit aligns the orientation of the specific page and the orientation of the output page with each other.

2. The image processing apparatus according to claim 1, wherein the control unit rotates the specific page and reduces a size of the specific page so as to align the orientation of the specific page and the orientation of the output page with each other.

3. The image processing apparatus according to claim 1, wherein the control unit specifies a cover page of the plurality of pages as the specific page,
wherein the control unit singly outputs the cover page on a single page.

4. The image processing apparatus according to claim 1, wherein the control unit specifies a first page of the plurality of pages as the specific page,
wherein the control unit singly outputs the first page on a single page.

5. The image processing apparatus according to claim 1, wherein the control unit specifies a page containing an indication of a chapter of the plurality of pages as the specific page,
wherein the control unit singly outputs the page containing the indication of the chapter on a single page.

6. The image processing apparatus according to claim 2, wherein the control unit reduces a size of the specific page based on a result of comparison of a length of a shorter edge of the output page and a length of a longer edge of the specific page.

7. The image processing apparatus according to claim 1, wherein the control unit places the specific page at a substantially center portion of the output page.

8. The image processing apparatus according to claim 2, wherein the control unit reduces a size of the specific page at a reduction ratio higher than or equal to a reduction ratio at which the certain number of pages are aggregated.

9. The image processing apparatus according to claim 2, wherein when the certain number is greater than or equal to 4, the control unit reduces a size of the specific page at a higher reduction ratio than a reduction ratio at which the certain number of pages are aggregated.

10. An image processing method comprising:
a first step of determining to process a plurality of pages by aggregating a certain number of pages among the plurality of pages into an output page,
a second step of specifying a specific page among the plurality of pages and excluding the specific page from an object of the aggregation, and
a third step performed when an orientation of the specific page is different from an orientation of the output page containing aggregated pages, the third step aligning the orientation of the specific page and the orientation of the output page with each other.

11. The image processing method according to claim 10, wherein the third step comprises:
rotating the specific page and reducing a size of the specific page so as to align the orientation of the specific page and the orientation of the output page with each other.

12. The image processing method according to claim 11, wherein the third step comprises:
reducing a size of the specific page based on a result of comparison of a length of a shorter edge of the output page and a length of a longer edge of the specific page.

13. The image processing method according to claim 10, wherein the third step comprises:
placing the specific page at a substantially center portion of the output page.

14. The image processing method according to claim 10, wherein the second step comprises:
specifying a cover page of the plurality of pages as the specific page, and excluding the cover page from the aggregation.

15. The image processing method according to claim 10, wherein the second step comprises:
specifying a first page of the plurality of pages as the specific page and excluding the first page from the aggregation.

16. The image processing method according to claim 10, wherein the second step comprises:
specifying a page containing an indication of a chapter of the plurality of pages as the specific page, and excluding the page containing the indication of the chapter from the aggregation.

17. The image processing method according to claim 11, wherein the third step comprising:
reducing a size of the specific page at a reduction ratio higher than or equal to a reduction ratio at which the certain number of pages are aggregated.

18. The image processing method according to claim 11, wherein the third step comprising:
reducing a size of the specific page at a higher reduction ratio than a reduction ratio at which the certain number of pages are aggregated, when the certain number is greater than or equal to 4.
